(19) United States
(12) Patent Application Publication
(10) Pub. No.: US 2007/0238044 A1
(43) Pub. Date: Oct. 11, 2007

(54) Calcium oxide dispersion liquid and process for production thereof

(76) Inventor: Keiichi Nakamura, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 11/578,605

(22) PCT Filed: Apr. 12, 2005
(86) PCT No.: PCT/JP05/07370

§ 371 Date: Oct. 16, 2006

Related U.S. Application Data
(60) Provisional application No. 60/564,973, filed on Apr. 26, 2004.

(30) Foreign Application Priority Data
Apr. 16, 2004 (JP) 2004-121615
Sep. 29, 2004 (JP) 2004-284677

(51) Int. Cl. G03G 5/00

(52) U.S. Cl. 430/137.17

(57) ABSTRACT

A calcium oxide dispersion liquid contains calcium oxide fine particles having a median particle diameter (volume basis) of 1 to 200 nm and a maximum particle diameter of 10 to 1,000 nm, and an organic dispersion medium. The calcium oxide dispersion liquid is produced by filling calcium oxide fine particles, an organic dispersion medium, and beads 5 to 200 μm in diameter into a container, and stirring these materials. Therefore, the calcium oxide having a small particle diameter and a high purity is homogeneously dispersed in the calcium oxide dispersion liquid.

### CROSS-REFERENCE TO RELATED APPLICATIONS

This application is an application filed under 35 U.S.C. §111 (a) claiming benefit pursuant to 35 U.S.C. §119(e) (1) of the filing date of Provisional Application 60/564,973 filed Apr. 26, 2004 pursuant to 35 U.S.C. §111(b).

### FIELD OF THE INVENTION

The present invention relates to a dispersion liquid of calcium oxide fine particles, and a process for production thereof. Specifically, the present invention relates to a high-concentration dispersion liquid of calcium oxide fine particles which have a small particle diameter and are homogeneously dispersed, and a process for production thereof.

### BACKGROUND OF THE INVENTION

Calcium oxide is highly hygroscopic, and is useful as a moisture absorbent and a dehydrating agent. The use as a moisture absorbent or a dehydrating agent requires calcium oxide to be highly active. Therefore, it is desirable that the particles thereof be nanoparticles having a large surface area, and that the particles contain as little calcium hydroxide and calcium carbonate as possible that are inactive in dehydration. Furthermore, calcium oxide manufactured on a nanoscale can give a paste having optical transparency. In addition, from the viewpoint of handling, calcium oxide is desirably provided in the form of a homogeneous dispersion liquid.

Calcium oxide has been produced by thermally decomposing limestone at about 1200° C. However, due to the high temperature, the particles thereof become enlarged in diameter and are sintered together to form a hard material. Accordingly, it takes a lot of energy and time to pulverize the resulting material into nanoparticles. However, calcium oxide for use as a moisture absorbent or a dehydrating agent should be prevented from absorbing moisture during production, and therefore time-consuming treatment is inappropriate. Furthermore, conventional synthetic methods of calcium oxide have difficulty in producing a dispersion liquid containing no inactive substances from particles having an extremely small particle diameter. In addition, the smaller the particle diameter of calcium oxide, the higher the slurry viscosity. Accordingly, it has been impossible to produce a high concentration slurry of calcium oxide nanoparticles by conventional techniques.

### DISCLOSURE OF THE INVENTION

It is an object of the present invention to provide a calcium oxide dispersion liquid in which highly purified calcium oxide having a small particle diameter is homogeneously dispersed, and a process for production thereof.

The inventors have developed a synthetic method of metal oxide nanoparticles by gas phase oxidation of an organometallic β-diketone complex. This method enables synthesis of primary particles having a median particle diameter of not more than 200 nm. Because the particles obtained are in the form of aggregates, they are pulverized by use of 50 μm fine beads and are dispersed in an optimum dispersion medium (alcohol or the like) to give a homogeneous dispersion liquid of calcium oxide fine particles. It has been revealed that the calcium oxide particles exhibit completely different dispersibility depending on the type of the dispersion medium. It has also been found that selection of the solvent in view of dipole moment and viscosity, or optimum mixing of the selected solvents leads to a stable dispersion liquid of calcium oxide nanoparticles. It has also been found that short-time treatment in an inert gas atmosphere can inhibit inactivation of calcium oxide.

The present invention basically pertains to the following [1] to [22].

[1] A calcium oxide dispersion liquid comprises:

calcium oxide fine particles having a median particle diameter (volume basis) of 1 to 200 nm and a maximum particle diameter of 10 to 1,000 nm; and

an organic dispersion medium.

[2] The calcium oxide dispersion liquid has a calcium oxide concentration of 10 to 50% by mass.

[3] The calcium oxide dispersion liquid is obtained by using the organic dispersion medium which has a water content of less than 1,000 ppm (by mass) as a raw material.

[4] In the calcium oxide dispersion liquid, the calcium oxide fine particles are obtained by vaporizing a calcium complex, and then oxidizing the resultant gaseous calcium complex in gas phase.

[5] In the calcium oxide dispersion liquid, the calcium oxide fine particles are obtained by vaporizing a calcium complex, oxidizing the resultant gaseous calcium complex in gas phase to obtain calcium oxide fine particles, and then subjecting the fine particles to baking treatment.

[6] In the calcium oxide dispersion liquid, the calcium complex is a complex of calcium and a β-diketone compound.

[7] In the calcium oxide dispersion liquid, the calcium oxide fine particles have a calcium hydroxide content of less than 5% by mass and a calcium carbonate content of less than 1% by mass.

[8] In the calcium oxide dispersion liquid, the organic dispersion medium is at least one medium selected from the group consisting of alcohol, nitrile compound, aamide compound and polyol derivative.

[9] In the calcium oxide dispersion liquid, the alcohol has 3 or more carbon atoms.

[10] In the calcium oxide dispersion liquid, the organic dispersion medium is diol derivative.

[11] In the calcium oxide dispersion liquid, the organic dispersion medium is at least one medium selected from the group consisting of acetonitrile, 1-butanol, 1-hexanol and 1-methoxy-2-propanol.

[12] In the calcium oxide dispersion liquid, the organic dispersion medium is a mixed dispersion medium.

[13] In the calcium oxide dispersion liquid, the organic dispersion medium is at least one medium selected from the group consisting of a nitrile compound/alcohol mixed dispersion medium, an aromatic compound/alcohol mixed dispersion medium, an aromatic compound/amine compound mixed dispersion medium, an ester/alcohol mixed dispersion medium, an amide compound/alcohol mixed dispersion medium, an aromatic compound/nitrile compound mixed dispersion medium and a polyol derivative/amine compound mixed dispersion medium.

[14] In the calcium oxide dispersion liquid, the mixed dispersion medium is at least one medium selected from the group consisting of a toluene/alcohol mixed dispersion medium, a butyl acetate/alcohol mixed dispersion medium, an N,N-dimethylacetamide/alcohol mixed dispersion medium, a diethylene glycol dimethyl ether/monoethanolamine mixed dispersion medium, a diethylene glycol dimethyl ether/diethanolamine mixed dispersion medium and a diethylene glycol dimethyl ether/triethanolamine mixed dispersion medium.

[15] The calcium oxide dispersion liquid contains a dispersant.

[16] In the calcium oxide dispersion liquid, the dispersant is at least one compound selected from nonionic surfactants.

[17] In the calcium oxide dispersion liquid, the nonionic surfactant has a hydroxyl group.

[18] In the calcium oxide dispersion liquid, the nonionic surfactant is an adduct of glycerin with polypropylene oxide.

[19] In the calcium oxide dispersion liquid, the organic dispersion medium has a viscosity of not more than 3.0 mPa·s (20° C.).

[20] A process for producing the calcium oxide dispersion liquid comprises the steps of:

filling calcium oxide fine particles, an organic dispersion medium, and beads having a diameter of 5 to 200 μm into a container; and

stirring these materials.

[21] In the process, the stirring is carried out in an atmosphere of an inert gas having a water content of not more than 10 ppm (by mol).

[22] In the process, the organic dispersion medium to be filled in the container has a water content of less than 1,000 ppm (by mass).

### EFFECTS OF THE INVENTION

The calcium oxide dispersion liquid according to the present invention is very useful as a moisture absorbent and a dehydrating agent because it hardly contains any calcium hydroxide and calcium carbonate which are inactive in dehydration, namely, the calcium oxide contained is highly purified. In addition, the dispersion liquid has high performance as a moisture absorbent since the calcium oxide particles are fine and have a large surface area. Further, application of the dispersion liquid gives a film having high transparency. Moreover, the dispersion liquid is very advantageous in terms of cost because the calcium oxide fine particles can be dispersed in high concentration. Owing to these characteristics, the calcium oxide dispersion liquid of the present invention can be applied to precision mechanical equipment and electronic materials (organic EL, ELD and the like).

The process for production of a calcium oxide dispersion liquid according to the present invention permits efficient production of the calcium oxide dispersion liquid having the above-described excellent properties.

### BRIEF DESCRIPTION OF THE DRAWINGS

FIG. 1 shows an embodiment of a production apparatus used for producing the calcium oxide fine particles according to the present invention; and

FIG. 2 is an electron microscope photograph of the calcium oxide fine particles obtained in Production Example 1.

### DESCRIPTION OF SYMBOLS

1 . . . Oxidizing substance
2 . . . Solution
3 . . . Mass flow controller
4 . . . Metering pump
5 . . . Preheater
6 . . . vaporizer
7 . . . Tubular heating furnace
8 . . . Collector

### PREFERRED EMBODIMENTS OF THE INVENTION

The calcium oxide dispersion liquid and process for production thereof according to the present invention are described in detail below.

### Calcium Oxide Dispersion Liquid

The calcium oxide dispersion liquid of the present invention comprises calcium oxide fine particles and an organic dispersion medium.

The calcium oxide fine particles have a median particle diameter (particle diameter at which the volume accumulation rate (mass accumulation rate shows the same value when the density of particles is constant) is 50%: D₅₀) of 1 to 200 nm, preferably 5 to 150 nm, and more preferably 10 to 100 nm, and have a maximum particle diameter of 10 to 1,000 nm, preferably 15 to 500 nm, more preferably 20 to 250 nm, and still more preferably 50 to 150 nm. Unfavorably, when the particle diameter is larger, problems arise such that fine processing is impossible and optical transparency is lowered, and the surface area decreases to reduce moisture absorption efficiency.

The median particle diameter and maximum particle diameter of the calcium oxide in the calcium oxide dispersion liquid are measured by laser Doppler method, optionally after the dispersion liquid is diluted with the same organic dispersion medium as used in the liquid. The measurements of the median particle diameter and maximum particle diameter can be carried out, for example, by Nanotrac UPA-EX150 or Microtrac UPA-150 manufactured by NIKKISO CO., LTD.

The organic dispersion medium is not particularly limited. Preferable examples thereof include organic solvents such as alcohols, nitrile compounds, amide compounds and polyol derivatives, mixtures of these solvents, aromatic compound/alcohol mixed dispersion media, aromatic compound/amine compound mixed dispersion media, ester/alcohol mixed dispersion media, aromatic compound/nitrile compound mixed dispersion media and diol derivative/amine compound mixed dispersion media. Furthermore, when an aggregation-inhibiting effect by electrostatic repulsion is desired, a protic solvent is preferable.

Examples of the alcohols include those having 1 to 10 carbon atoms such as methanol, ethanol, propanol, isopropanol, butanol, pentanol, hexanol, heptanol, octanol, cyclopentanol and cyclohexanol. In particular, the alcohols having 3 or more carbon atoms are preferable because of the high reaggregation-inhibiting effect and low hygroscopicity. Of these alcohols, 1-butanol is particularly preferable.

The nitrile compounds are organic solvents having a cyano group (—CN). Examples thereof include nitrile compounds having 1 to 10 carbon atoms such as acetonitrile, succinonitrile, propionitrile, butyronitrile, acrylonitrile, adiponitrile and benzonitrile. Of these compounds, acetonitrile is particularly preferable.

The amide compounds are organic solvents having an amide group. Examples thereof include formamide, N-methylformamide, N,N-dimethylformamide, N,N-diethylformamide, acetamide, N-methylacetamide, N,N-dimethylacetamide, N,N-diethylacetamide and N-methylpropionamide.

The polyol derivatives are preferably polyol monoethers, polyol diethers, polyol monoesters and polyol diesters.

Examples of the polyol derivatives include diol derivatives such as 1-methoxy-2-propanol, 1-ethoxy-2-propanol, 1-butoxy-2-propanol, diethylene glycol ethyl methyl ether, diethylene glycol diethyl ether, diethylene glycol dibutyl ether, diethylene glycol dimethyl ether, diethylene glycol monoethyl ether, diethylene glycol monoethyl ether acetate, diethylene glycol monobutyl ether, diethylene glycol monobutyl ether acetate, diethylene glycol monomethyl ether, ethylene glycol diacetate, ethylene glycol diethyl ether, ethylene glycol dibutyl ether, ethylene glycol dimethyl ether, ethylene glycol monoacetate, ethylene glycol monoisopropyl ether, ethylene glycol monoethyl ether, ethylene glycol monoethyl ether acetate, ethylene glycol monobutyl ether, ethylene glycol monobutyl ether acetate, ethylene glycol monohexyl ether, ethylene glycol monomethyl ether, ethylene glycol monomethyl ether acetate and ethylene glycol monomethoxymethyl ether; and derivatives of polyol having 3 or more hydroxyl groups, such as glycerol monoacetate, glycerol diacetate, glycerol triacetate and glycerol dialkyl ether (for example, 1,2-dimethyl glycerol, 1,3-dimethyl glycerol, 1,3-diethyl glycerol). Of these derivatives, 1-methoxy-2-propanol is particularly preferable.

The organic dispersion medium used for the calcium oxide dispersion liquid of the present invention may be a mixed dispersion medium consisting of two or more kinds of the organic dispersion media. The mixed dispersion medium permits production of a higher concentration calcium oxide dispersion liquid. Examples of the preferable mixed dispersion media are described below.

### Nitrile Compound/Alcohol Mixed Dispersion Media

Examples of the nitrile compounds and alcohols used for the mixed dispersion media are as described above. Preferred combinations include acetonitrile and the alcohol (particularly 1-butanol or 1-hexanol). The mixed dispersion medium preferably has an alcohol concentration of 0.005 to 50% (by mass), more preferably 0.01 to 10%, and most preferably 0.01 to 0.5%.

The mixed dispersion medium may contain a third solvent component. Examples of the third components include amine compounds, such as monoethanolamine, diethanolamine, triethanolamine, monoethylamine, diethylamine, triethylamine and ethylenediamine.

### Aromatic Compound/Alcohol Mixed Dispersion Media

Examples of the aromatic compounds include benzene, toluene, xylene and ethylbenzene. The alcohols include those described above. Preferred combinations include toluene/1-hexanol, xylene/1-hexanol and ethylbenzene/1-hexanol.

The mixed dispersion medium preferably has an alcohol concentration of 0.005 to 50% (by mass), more preferably 0.01 to 10%, and most preferably 0.01 to 0.5%. The mixed dispersion medium may contain a third component. Examples of the third components include the above-described amine compounds.

### Aromatic Compound/Amine Compound Mixed Dispersion Media

The aforementioned aromatic compounds can be used herein. Examples of the amine compounds include monoethanolamine, diethanolamine, triethanolamine, monoethylamine, diethylamine, triethylamine and ethylenediamine. Preferred combinations include xylene/monoethanolamine. The mixed dispersion medium preferably has an amine compound concentration of 0.005 to 50% (by mass), more preferably 0.01 to 10%, and most preferably 0.01 to 5%.

### Ester/Alcohol Mixed Dispersion Media

Preferred examples of the esters include ethyl formate, propyl formate, butyl formate, methyl acetate, ethyl acetate, propyl acetate, butyl acetate, pentyl acetate, methyl pivalate and ethyl pivalate. The alcohols are as described above. Preferred combinations include butyl acetate/1-butanol, butyl acetate/1-hexanol and alkyl pivalate/1-hexanol.

The mixed dispersion medium may contain a third component. Examples of the third components include the above-described amine compounds. The mixed dispersion medium preferably has an alcohol concentration of 0.005 to 50% (by mass), more preferably 0.01 to 10%, and most preferably 0.01 to 0.5%.

### Amide Compound/Alcohol Mixed Dispersion Media

The amide compounds and alcohols are as described hereinabove. Preferred combinations include N,N-dimethylformamide/alcohol (particularly 1-butanol or 1-hexanol), and N,N-dimethylacetamide/alcohol (particularly 1-butanol or 1-hexanol). The mixed dispersion medium may contain a third component. Examples of the third components include amine compounds. The mixed dispersion medium preferably has an alcohol concentration of 0.005 to 50% (by mass), more preferably 0.01 to 10%, and most preferably 0.01 to 0.5%.

### Aromatic Compound/Nitrile Compound Mixed Dispersion Media

The aromatic compounds and nitrile compounds are as described hereinabove. The mixed dispersion medium may contain a third component. Examples of the third components include amine compounds. The mixed dispersion medium preferably has a nitrile compound concentration of 0.005 to 50% (by mass), more preferably 0.01 to 10%, and most preferably 0.01 to 0.5%.

### Polyol Derivative/Amine Compound Mixed Dispersion Media

The aforementioned polyol derivatives and amine compounds can be used herein. Preferred combinations include diethylene glycol dimethyl ether/amine compound (particularly, hydroxyl-containing amine compounds such as monoethanolamine, diethanolamine and triethanolamine). The mixed dispersion medium may contain a third component.

The mixed dispersion medium preferably has an amine compound concentration of 0.005 to 50% (by mass), more preferably 0.01 to 10%, and still more preferably 0.01 to 5%.

The calcium oxide dispersion liquid may contain a dispersant. The dispersant provides enhanced fluidity and stability, and therefore the diameter of dispersed particles can be reduced. The dispersant is not particularly limited. Nonionic surfactants, particularly those containing a hydroxyl group, are suitable.

The nonionic surfactants include ether surfactants such as polyoxyethylene alkyl ether, polyoxyethylene secondary alcohol ether, polyoxyethylene alkylphenyl ether, polyoxyethylene, polyoxypropylene block copolymers, polyoxyethylene polyoxypropylene alkyl ether and adduct of glycerin with polypropylene oxide; and ester ether surfactants such as polyoxyethylene glycerin fatty acid ester, polyoxyethylene castor oil and hardened castor oil, and polyoxyethylene sorbitan fatty acid ester. Of these, adduct of glycerin with polypropylene oxide is particularly preferred.

The amount of dispersant is dependent on the compound selected, and preferably ranges from 0.1 to 10% (by mass) relative to calcium oxide.

The dispersant may be added to the dispersion medium before or after calcium oxide is dispersed in the dispersion medium with a bead mill. Preferably, the addition is performed prior to dispersing with a bead mill, in which case the fluidity and stability are further enhanced.

The organic dispersion medium used as a raw material in the present invention preferably has a low water content before calcium oxide is dispersed, generally less than 1,000 ppm (by mass), preferably 500 ppm (by mass), more preferably less than 100 ppm (by mass), still more preferably less than 10 ppm (by mass), and still more preferably less than 5 ppm (by mass). The calcium oxide dispersion liquid having a water content in the above range is preferable because there is no increase of calcium hydroxide content and problems such as coloration and viscosity increase do not occur. The organic dispersion medium having this low water content can be obtained by dehydration with molecular sieves or calcium oxide.

The water content of the organic dispersion medium is measured using a coulometric Karl Fischer moisture titrator suchas CA-06 manufactured by Mitsubishi Chemical Corporation.

The calcium oxide dispersion liquid according to the present invention preferably has a calcium oxide concentration of 10 to 50% by mass, more preferably 20 to 50% by mass, still more preferably 25 to 50% by mass, and most preferably 30 to 50% by mass. When the calcium oxide concentration is lower than the above-described range, a large amount of the dispersion medium is required for preparing the calcium oxide dispersion liquid in order to obtain moisture absorption effect. When the calcium oxide concentration is higher than the above-described range, the dispersion liquid has an increased viscosity to cause difficult handling. The calcium oxide concentration in the dispersion liquid can be calculated from the amounts of the raw materials to be used when preparing the dispersion liquid, and can be determined by the following method (a) or (b) after preparation of the dispersion liquid.

(a) The dispersion medium is removed from the dispersion liquid by a method such that the dispersion medium is evaporated off under reduced pressure by a rotary evaporator or such that the dispersion liquid is heated to 200° C. in the atmosphere. The resulting residue is dissolved in an acid such as hydrochloric or sulfuric acid, and the solution is diluted with pure water, followed by measuring the calcium concentration using an atomic absorption measuring apparatus (for example, atomic absorption spectrophotometer SAS-7500A manufactured by Seiko Instruments Inc.) or an ICP measuring apparatus (for example, ICP mass spectrometer SPQ-9000 manufactured by Seiko Instruments Inc.) to determine the calcium oxide concentration in the dispersion liquid by calculation.

(b) The dispersion medium is removed from the dispersion liquid as described in the method (a). The resulting residue is heated to 1,000° C. under atmosphere pressure using a thermobalance apparatus (for example, TG/DTA6200 model manufactured by Seiko Instruments Inc.) to afford residual calcium oxide. The weight of the residual calcium oxide is measured to calculate the calcium oxide concentration in the dispersion liquid.

In the calcium oxide dispersion liquid according to the present invention, the calcium oxide fine particles have a calcium hydroxide content of less than 5% by mass, and preferably less than 1% by mass, and have a calcium carbonate content of less than 1% by mass, and preferably less than 0.5% by mass. The calcium oxide dispersion liquid containing calcium hydroxide and calcium carbonate in the above-described range has high performance as a moisture absorbent and a dehydrating agent because of substantial absence of calcium hydroxide and calcium carbonate inactive in dehydration.

The calcium hydroxide content and calcium carbonate content are measured by a thermobalance apparatus. The calcium hydroxide content is calculated from weight reduction that is caused by dehydration of calcium hydroxide occurring at around 300° C. The calcium carbonate content is calculated from weight reduction that is caused by decarboxylation of calcium carbonate taking place at about 700° C.

The viscosity of the dispersion medium is preferably low in order to produce the dispersion liquid of calcium oxide fine particles in high concentration. The viscosity is preferably not more than 3.0 mPa·s (20° C.), and still preferably not more than 1.0 mPa·s (20° C.). In the case of the mixed dispersion medium, the viscosity of the mixed dispersion medium preferably falls in the above-described range.

### Process for Producing Calcium Oxide Dispersion Liquid

It is usually difficult to further pulverize micrometer or larger sized particles of calcium oxide to a median particle diameter of not more than 200 nm. Accordingly, it is preferable that the calcium oxide particles to be dispersed in the dispersion medium have a median particle diameter of not more than 200 nm.

The calcium oxide fine particles having this particle diameter can be obtained, for example, by a method in which a calcium complex such as a complex of calcium and a β-diketone compound (β-diketone/calcium complex) or a calcium alkoxide is vaporized, and the resulting gaseous calcium complex is combusted in the presence of an oxidizing substance.

Alternatively, the calcium oxide fine particles can be obtained by a method in which a solution of a β-diketone/calcium complex (in a solvent such as an alcohol) is vaporized, the vapor containing the gaseous β-diketone/calcium complex is mixed with a gaseous oxidizing substance (air or the like), and the resulting mixture is heated to combust the gaseous β-diketone/calcium complex.

Preferred β-diketone/calcium complexes for use in the present invention include calcium complexes of 2,2,6,6-tetramethylheptane-3,5-dione (DPM.H), 2,6-dimethyl-3,5-heptanedione (DMHD.H) and 2,4-pentanedione (acac.H). Specific examples include Ca(DPM)₂, Ca(DMHD)₂, Ca (acac)₂ and n-hydrates thereof (n is a number of 1 or more) As used herein, “acac” or the like means a ligand produced by elimination of H⁺ from acac.H or the like.

Preferred examples of the calcium alkoxides for use in the present invention include calcium methoxide, calcium ethoxide, calcium n-propoxide, calcium i-propoxide, calcium n-butoxide, calcium sec-butoxide, calcium tert-butoxide and calcium t-amyloxide. Specific examples include calcium dimethoxide, calcium diethoxide and calcium di-i-propoxide. These calcium complexes may be used in combination of two or more kinds.

Examples of the gaseous calcium complexes include those obtained by heat vaporizing solid or liquid calcium complexes, those obtained by heat vaporizing calcium complex solutions, and mixtures thereof.

The gaseous calcium complex may be a vapor of one kind of the calcium complex or a mixed vapor of two or more kinds of the calcium complexes. The mixed vapor of two or more kinds of the calcium complexes may be obtained by mixing two or more kinds of the calcium complexes followed by vaporization, or by vaporizing two or more kinds of the calcium complexes followed by mixing.

Because the alkoxide is liable to be hydrolyzed, the use of the calcium alkoxide complex often results in problems such as decomposition before the vaporization to cause a lower yield and pipe clogging. Therefore, it is preferable that the alkoxide be stabilized in the form of an organic solvent solution and then vaporized.

When the gaseous calcium complex is prepared by heat vaporizing a calcium complex solution, it may contain a vapor of one kind of the calcium complex or a vapor of two or more kinds of the calcium complexes. When the gaseous calcium complex contains a vapor of two or more kinds of the calcium complexes, it may be prepared by vaporizing two or more solutions containing different calcium complexes followed by mixing, or may be prepared by vaporizing a solution containing two or more kinds of the calcium complexes.

The solvent used for the calcium complex solution is selected from methyl alcohol, ethyl alcohol, propyl alcohol, butyl alcohol, tetrahydrofuran, dimethyl sulfoxide, dimethylformamide, hexane, cyclohexane, methylcyclohexane, dioxane, acetone, ethyl acetate, butyl acetate, methyl isobutyryl ketone, diethyl ether, t-butyl methyl ether, acetyl acetone, diisobutyrylmethane and dipivaloylmethane. These solvents can be used singly or in combination of two or more kinds. The concentration of the solution is not particularly limited.

In the present invention, an inert gas such as nitrogen or argon may be used as a carrier for the gaseous calcium complex.

Examples of the oxidizing substances for use in the present invention include oxygen, mixed gases of oxygen with another gas, for example, an inert gas such as nitrogen or argon, in an arbitrary proportion, air, water and nitrous oxide. These oxidizing substances may be used singly or in combination of two or more kinds.

Prior to combusting the calcium complex, the gaseous calcium complex and the oxidizing substance may be preheated separately at temperatures lower than the decomposition temperature of the calcium complex. It is also possible that the gaseous calcium complex and the oxidizing substance be mixed together and be preheated at temperatures lower than the decomposition temperature of the calcium complex. Furthermore, the gaseous calcium complex may be mixed with the oxidizing substance prior to the combustion. It is also possible that the gaseous calcium complex be heated at temperatures not lower than the decomposition temperature of the calcium complex and be released into the oxidizing substance to perform combustion simultaneously with the mixing with the oxidizing substance. When the calcium complex is in a liquid form or in a solution form dissolved in an organic solvent, it may be mixed directly with the oxidizing substance.

The calcium complex and the oxidizing substance are preferably mixed together under conditions such that a completely mixed state is achieved.

It is preferable that the gaseous calcium complex and the oxidizing substance be combusted after mixed together. The combustion may be started by using an ignition source or by heating them at a temperature not lower than the ignition point.

Insufficient mixing will lead to incomplete combustion of the calcium complex, in which case unreacted materials such as carbides and water remain and the fine particles are fused by prolonged reaction time. As a result, the quality and particle diameter become unstable and the resulting particles generally have large diameters.

In the mixed gas of the oxidizing substance with the gaseous calcium complex or the gas generated by vaporization of the calcium complex solution, it is preferable that the concentration of the calcium complex be in the range of explosion. When the concentration is out of the range, the combustion is not stable. When the vapor pressure of the calcium complex is low and the range of explosion is not reached, a combustion improver is preferably used. The combustion improver is not particularly limited. For example, when using the calcium complex solution, the solvent of the solution can be used as the combustion improver.

When using the gaseous calcium complex prepared by heat vaporizing a solid or liquid calcium complex, the oxidizing substance is used in an oxygen molar amount 0.5 to 40 times, preferably 1 to 30 times, and more preferably 1 to 20 times that required to completely oxidize the calcium complex. When using the gaseous calcium complex prepared by heat vaporizing a calcium complex solution, the oxidizing substance is used in an oxygen molar amount 0.5 to 40 times, preferably 1 to 30 times, and more preferably 1 to 20 times that required to completely oxidize the calcium complex and the solvent. When the oxygen amount of the oxidizing substance used is too small, unreacted raw materials can cause the resulting calcium oxide fine particles to aggregate. When the oxygen amount is too large, the organic substance concentration becomes lower than the explosion limit and the combustion is not stable.

The combustion temperature in the present invention is preferably not lower than 400° C., particularly preferably in the range of 500 to 1500° C. When the combustion temperature is lower, unreacted raw materials or incompletely combusted organic components remain. When the combustion temperature is too high, the apparatus lifetime is shortened and contaminations occur due to deterioration of the apparatus materials.

The calcium oxide fine particles thus prepared range in median particle diameter (volume basis) from 1 to 200 nm.

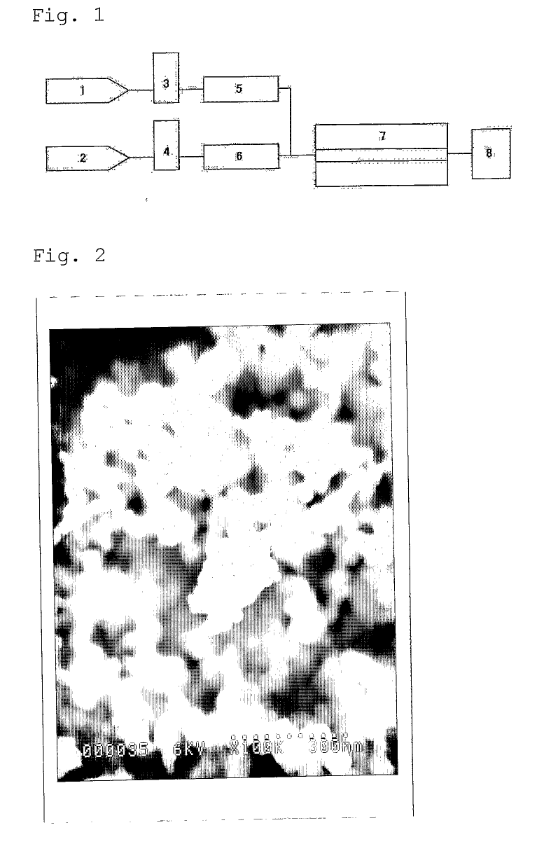

More specifically, the aforesaid process for producing the calcium oxide fine particles may employ an apparatus as shown in FIG. 1.

FIG. 1 is a schematic diagram showing an embodiment of a production apparatus used in the process for producing the calcium oxide fine particles according to the present invention.

A solution 2 of β-diketone/calcium complex is quantitatively fed into a heating vaporizer 6 through a metering pump 4, and is vaporized here. The vapor containing the gaseous β-diketone/calcium complex vaporized in the heating vaporizer 6 is quantitatively fed to a coaxial nozzle of an inlet of a tubular heating furnace 7 by quantitatively feeding a carrier gas into the heating vaporizer 6 through the metering pump 4. An oxidizing substance 1 (such as air) is quantitatively fed into a preheater 5 through a mass flow controller 3, and the preheated oxidizing substance 1 is quantitatively fed to the coaxial nozzle of the inlet of the tubular heating furnace 7. The vaporized β-diketone/calcium complex and the oxidizing substance, which are fed through the coaxial nozzle, are mixed quickly and combusted (oxidation reaction) in the tubular heating furnace 7 to generate calcium oxide fine particles. The resultant calcium oxide fine particles are collected by means of a collector 8.

The above-obtained calcium oxide fine particles generally contain calcium hydroxide (Ca(OH)₂) or calcium carbonate (CaCO₃) as impurities. Therefore, in order to convert these impurities into calcium oxide, a baking treatment is preferably carried out at 500 to 1,000° C. In the present invention, the treatment for converting Ca(OH)₂ and CaCO₃ contained in the calcium oxide fine particles into CaO will be referred to as baking treatment.

Since the calcium oxide is extremely hygroscopic, a little water or the like can work on calcium oxide (CaO) to form calcium hydroxide (Ca(OH)₂) or calcium carbonate (CaCO₃) during the above procedure. To prevent the calcium oxide from containing such impurities, operations such as taking out the calcium oxide fine particles produced are preferably carried out in an atmosphere containing little or no water (for example, in a dry nitrogen glove box), for example in an atmosphere having a water content of not more than 10 ppm (by mol).

The calcium oxide dispersion liquid according to the present invention can be produced by dispersing the calcium oxide fine particles produced as described above in the aforesaid organic dispersion medium.

The calcium oxide fine particles prepared by the above method sometimes contain aggregated primary particles. Various methods are employable for pulverizing the aggregates, with examples including use of a bead mill or a jet mill. For pulverization into nanoparticles, a bead mill is preferably used. The smaller the bead size, the higher the pulverization dispersion speed and the smaller the particle diameter achieved. Accordingly, the beads for use particularly preferably range in diameter from 5 to 200 μm, and particularly from 10 to 100 μm. From the viewpoints of abrasion resistance and minimization of impurity contamination in calcium oxide, the beads are preferably made of zirconia.

Addition of the organic dispersion medium in the pulverizing operation enables production of the dispersion liquid as soon as the pulverization of the aggregates completes.

Specifically, production of the dispersion liquid simultaneously with the bead mill pulverization may be performed by a process in which the calcium oxide fine particles prepared by the above method, the aforementioned organic dispersion medium, and the beads are filled in a container and are stirred. In this process, the filling rate of the beads is preferably in the range of 85 to 95%, and the calcium oxide fine particles are preferably used in an amount of 1 to 50% by mass relative to the total amount (100% by mass) of the calcium oxide fine particles and the organic dispersion medium. The stirring time may be appropriately determined depending on the desired median particle diameter, and is generally about 10 minutes to 5 hours.

The pulverizing and dispersing operations are preferably carried out in an inert gas atmosphere in order to inhibit the calcium oxide from absorbing moisture of the atmosphere. Examples of the inert gases include noble gases such as helium and argon, and nitrogen. The inert gas to be used preferably has a water content of not more than 10 ppm (by mol). When the inert gas has a high water content, the dispersion liquid absorbs moisture during the dispersion treatment, leading to problems such as increase of calcium hydroxide, viscosity increase and coloration.

Prior to producing the dispersion liquid simultaneously with the bead mill pulverization, the calcium oxide may be pre-dispersed in the dispersion liquid by means of ultrasonic wave, a planetary mixer or the like.

The above-described process affords a dispersion liquid in which calcium oxide fine particles are homogeneously dispersed. In the present invention, the “dispersion liquid in which calcium oxide fine particles are homogeneously dispersed” means that both fluidity and stability tests mentioned below of the dispersion liquid result in evaluation of “AA”.

### EXAMPLES

The present invention will be described in more detail with reference to the following examples, but it should be construed that the invention is in no way limited to the examples.

Analysis Methods

[Median Particle Diameter and Maximum Particle Diameter]

These particle diameters were measured using a particle size distribution analyzer (Microtrac UPA-150 model manufactured by NIKKISO CO., LTD).

Measurement condition: The dispersion liquid to be tested was diluted by 100 times with the same solvent as used in the dispersion liquid.

[BET Surface Area]

Measuring apparatus: Chem BET-3000 manufactured by QUANTA CHROME CORP.

[Amounts of Calcium Hydroxide and Calcium Carbonate]

A thermobalance was used in this method.

Thermobalance: TG/DTA6200 model manufactured by Seiko Instruments Inc.

Measurement temperature range: 30 to 1,000° C.

Heating rate: 10° C./min

N₂ atmosphere: 200 ml/min

The amount of calcium hydroxide was determined by calculation from weight reduction that had been caused by dehydration of calcium hydroxide occurring at about 300° C.

The amount of calcium carbonate was determined by calculation from weight reduction that had been caused by decarboxylation of calcium carbonate taking place at about 700° C.

### Production Example 1

Calcium oxide fine particles were produced using an apparatus as shown in FIG. 1. Into a vaporizer 6 heated at 250° C., a mixed solution of 300 g of Ca(DPM)₂ (manufactured by SHOWA DENKO K.K.) and 700 g of methanol was fed at a flow rate of 4 mL/min and was vaporized. Air 1 was flowed into a preheater 5 at a rate of 40 L/min and was heated to 250° C. The gaseous Ca(DPM)₂ and the methanol, and the air were fed to a coaxial nozzle of an inlet of a tubular electric furnace 7. The combustion temperature in the tubular electric furnace 7 was set at 950° C. The combustion time was 1 second. The oxygen molar amount in the air fed was 1.5 times that required to completely oxidize the Ca(DPM)₂ and methanol. As a result, calcium oxide fine particles were collected in a collector 8 in a yield of 90%. The calcium oxide fine particles had a median particle diameter of 30 nm. The fine particles are shown in a photograph of FIG. 2.

The above-obtained fine particles contained calcium carbonate and calcium hydroxide as impurities. In order to remove these impurities, an annealing treatment was carried out in an air atmosphere at 550° C. for 5 hours, and further at 580° C. for 3 hours. The generated calcium oxide particles had a BET surface area of 20 m²/g, which corresponds to an arithmetic mean particle diameter of 88 nm.

Thermogravimetric analysis was performed using the thermobalance apparatus (TG/DTA6200 manufactured by Seiko Instruments Inc.) to measure the calcium hydroxide and calcium carbonate contents. Both contents were determined to be less than 1% by mass, respectively.

### Example 1

56 g of the calcium oxide particles obtained in Production Example 1 were mixed with 504 g of 1-butanol having a water content of 9 ppm (by mass). The mixture was ultrasonicated for 1 hour to afford a homogeneous dispersion liquid. This dispersion liquid was treated in nitrogen atmosphere (water content: 8 ppm (by mol)) for 2 hours by use of a bead mill (UAM-015 manufactured by Kotobuki Engineering and Manufacturing Co., Ltd.) containing 50-μm zirconium oxide beads. As a result, a dispersion liquid having a calcium oxide concentration of 10% by mass was obtained. The dispersion liquid was diluted by 100 times and was analyzed with the particle size distribution analyzer to determine the particle size distribution, resulting in a median particle diameter of 84 nm and a maximum particle diameter of 400 nm. The calcium hydroxide content and calcium carbonate content were determined to be less than 5% by mass and less than 1% by mass respectively.

### Comparative Example 1

5 g of the calcium oxide particles obtained in Production Example 1 were mixed with 95 g of 1-butanol having a water content of 8 ppm (by mass). The mixture was ultrasonicated for 1 hour to afford a homogeneous dispersion liquid. The dispersion liquid was analyzed with the particle size distribution analyzer (Microtrac UPA-150 manufactured by NIKKISO CO., LTD) to determine the particle size distribution, resulting in a median particle diameter of 340 nm and a maximum particle diameter of 1,370 nm.

### Examples 2 to 13

Examples 2 to 13 were carried out in which the kind of the dispersion medium and the calcium oxide concentration were changed.

Calcium oxide particles having a BET surface area of 18 m²/g (which corresponds to an arithmetic mean particle diameter of 100 nm) were obtained by the same method as in Production Example 1 except that the second annealing treatment was carried out at 700° C. for 1 hour. The calcium oxide particles were mixed with 312 g of the dispersion medium (media) shown in Table 1, so as to achieve a calcium oxide concentration shown in Table 1. The mixture was ultrasonicated for 1 hour to afford a homogeneous dispersion liquid. All the (mixed) dispersion media used in these examples had a water content of not more than 1,000 ppm. The dispersion liquid was treated in nitrogen atmosphere (water content: 8 ppm (by mol)) for 2 hours by use of a bead mill containing 50-μm zirconium oxide beads. As a result, a calcium oxide dispersion liquid having a concentration shown in Table 1 was obtained in each example. After the dispersion liquid had been diluted by 100 times, the particle size distribution was measured with the particle size distribution analyzer to determine the median particle diameter and the maximum particle diameter. In each example, the calcium hydroxide content and the calcium carbonate content were determined to be less than 5% by mass and less than 1% by mass. respectively.

The dispersion medium kinds, the calcium oxide concentrations, and the results are shown in Table 1.

The dispersion liquid of Example 2 was allowed to stand at room temperature for 7 days, and its particle size distribution was measured again. The measurement resulted in a median particle diameter of 90 nm and a maximum particle diameter of 400 nm, which proved that the obtained dispersion liquid was extremely stable.

The dispersion liquids of Examples 1 to 13 had a smaller median particle diameter and a smaller maximum particle diameter than those obtained in Comparative Example 1. This result probably shows that the secondary aggregates were pulverized by the bead mill.

Further, the results provide that the dispersion treatment in nitrogen atmosphere inhibits moisture absorption of the calcium oxide to a satisfactory level.

### Example 14

A calcium oxide dispersion liquid was produced in the same manner as in Example 13, except that 0.9 g of diethanol amine as dispersion medium-2 and 3.7 g of GL-100 (available from Asahi Denka Co., Ltd.) as dispersant were added to the dispersion liquid prior to the bead mill treatment. The median particle diameter and the maximum particle diameter were 60 nm and 240 nm, respectively. The dispersion liquid was allowed to stand at room temperature for 7 days, and its particle size distribution was measured again. The measurement resulted in the same results, i.e., a median particle diameter of 60 nm and a maximum particle diameter of 240 nm, which proved that the obtained dispersion liquid was extremely stable.

TABLE 1

| | | Dispersion | Dispersion | Median particle | | | |
|---|---|---|---|---|---|---|---|
| | | medium-1 | Medium-2 | diameter | | | |
| | Calcium oxide | Kind and | Kind and | (Maximum particle | | | |
| | concentration | concentration | concentration | diameter) | | Fluidity | Stability |
| Example 1 | 10% by mass | 1-Butanol | None | 84 | nm | AA | AA |
| | | 100% by mass | | (400 | nm) | | |
| Comparative | 5% by mass | 1-Butanol | None | 340 | nm | AA | CC |
| Example 1 | | 100% by mass | | (1,370 | nm) | | |
| Example 2 | 15% by mass | 1-Butanol | None | 100 | nm | AA | AA |
| | | 100% by mass | | (250 | nm) | | |
| Example 3 | 15% by mass | 1-Hexanol | None | 80 | nm | AA | AA |
| | | 100% by mass | | (350 | nm) | | |
| Example 4 | 20% by mass | Xylene | Monoethanolamine | 85 | nm | AA | AA |
| | | 99.5% by mass | 0.5% by mass | (400 | nm) | | |
| Example 5 | 20% by mass | Toluene | 1-Hexanol | 75 | nm | AA | AA |
| | | 99.5% by mass | 0.5% by mass | (300 | nm) | | |
| Example 6 | 20% by mass | Acetonitrile | None | 80 | nm | AA | AA |
| | | 100% by mass | | (360 | nm) | | |
| Example 7 | 30% by mass | Acetonitrile | 1-Butanol | 85 | nm | AA | AA |
| | | 99.9% by mass | 0.1% by mass | (350 | nm) | | |
| Example 8 | 30% by mass | Acetonitrile | 1-Hexanol | 75 | nm | AA | AA |
| | | 99.9% by mass | 0.1% by mass | (300 | nm) | | |
| Example 9 | 25% by mass | DMF | 1-Hexanol | 85 | nm | AA | AA |
| | | 99.9% by mass | 0.1% by mass | (400 | nm) | | |
| Example 10 | 30% by mass | DMAC | 1-Hexanol | 75 | nm | AA | AA |
| | | 99.9% by mass | 0.1% by mass | (300 | nm) | | |
| Example 11 | 30% by mass | Butyl acetate | 1-Hexanol | 75 | nm | AA | AA |
| | | 99.9% by mass | 0.1% by mass | (300 | nm) | | |
| Example 12 | 20% by mass | Diglyme | Monoethanolamine | 85 | nm | AA | AA |
| | | 99.9% by mass | 0.1% by mass | (390 | nm) | | |
| Example 13 | 30% by mass | PGME | None | 83 | nm | AA | AA |
| | | 100.0% by mass | | (240 | nm) | | |
| Example 14 | 30% by mass | PGME | Diethanolamine | 60 | nm | AA | AA |
| | | 99.6% by mass | 0.4% by mass | (240 | nm) | | |

“Calcium oxide concentration” shows calcium oxide concentrations in the dispersion liquids.

“Dispersion medium-1” shows kinds and concentrations (concentration of Dispersion medium-1 in the dispersion medium) of Dispersion medium-1.

“Dispersion medium-2” shows kinds and concentrations (concentration of Dispersion medium-2 in the dispersion medium) of Dispersion medium-2.

Abbreviations of the dispersion media:

DMF=N,N-dimethylformamide

DMAC=N,N-dimethylacetamide

Diglyme=diethylene glycol dimethyl ether

PGME=1-methoxy-2-propanol (propylene glycol monomethyl ether)

“Median particle diameter” shows median particle diameters (volume basis) of calcium oxide in the dispersion liquids. The numbers in parentheses show maximum particle diameters.

“Fluidity” shows fluidities of the dispersion liquids. A 180-ml clear glass container (50 mm in diameter) having a cap was filled with 50 ml of the dispersion liquid. The container was then quickly tilted 90 degrees, and the fluidity of the liquid was observed. This measurement was carried out at room temperature.

AA . . . The dispersion liquid flowed as soon as the container was tilted.

BB . . . The dispersion liquid flowed slowly after the container had been tilted.

CC . . . The dispersion liquid did not flow even after the container had been tilted.

“Stability”: A 180-ml clear glass container (50 mm in diameter) having a cap was filled with 50 ml of the dispersion liquid. The container was kept at room temperature for 1 week, and the dispersion liquid was observed.

AA . . . No change was observed.

BB . . . A clear supernatant was observed.

CC . . . Precipitation was observed.

1. A calcium oxide dispersion liquid comprising:
calcium oxide fine particles having a median particle diameter (volume basis) of 1 to 200 nm and a maximum particle diameter of 10 to 1,000 μm; and
an organic dispersion medium.

2. The calcium oxide dispersion liquid according to claim 1, which has a calcium oxide concentration of 10 to 50% by mass.

3. The calcium oxide dispersion liquid according to claim 1, which is obtained by using the organic dispersion medium which has a water content of less than 1,000 ppm (by mass) as a raw material.

4. The calcium oxide dispersion liquid according to claim 1, wherein the calcium oxide fine particles are obtained by vaporizing a calcium complex, and then oxidizing the resultant gaseous calcium complex in gas phase.

5. The calcium oxide dispersion liquid according to claim 1, wherein the calcium oxide fine particles are obtained by vaporizing a calcium complex, oxidizing the resultant gaseous calcium complex in gas phase to obtain calcium oxide fine particles, and then subjecting the fine particles to baking treatment.

6. The calcium oxide dispersion liquid according to claim, wherein the calcium complex is a complex of calcium and a β-diketone compound.

7. The calcium oxide dispersion liquid according to claim 1, wherein the calcium oxide fine particles have a calcium hydroxide content of less than 5% by mass and a calcium carbonate content of less than 1% by mass.

8. The calcium oxide dispersion liquid according to claim 1, wherein the organic dispersion medium is at least one medium selected from the group consisting of alcohol, nitrile compound, amide compound and polyol derivative.

9. The calcium oxide dispersion liquid according to claim 8, wherein the alcohol has 3 or more carbon atoms.

10. The calcium oxide dispersion liquid according to claim 8, wherein the organic dispersion medium is diol derivative.

11. The calcium oxide dispersion liquid according to claim 1, wherein the organic dispersion medium is at least one medium selected from the group consisting of acetonitrile, 1-butanol, 1-hexanol and 1-methoxy-2-propanol.

12. The calcium oxide dispersion liquid according to claim 1, wherein the organic dispersion medium is a mixed dispersion medium.

13. The calcium oxide dispersion liquid according to claim 12, wherein the organic dispersion medium is at least one medium selected from the group consisting of a nitrile compound/alcohol mixed dispersion medium, an aromatic compound/alcohol mixed dispersion medium, an aromatic compound/amine compound mixed dispersion medium, an ester/alcohol mixed dispersion medium, an amide compound/alcohol mixed dispersion medium, an aromatic compound/nitrile compound mixed dispersion medium and a polyol derivative/amine compound mixed dispersion medium.

14. The calcium oxide dispersion liquid according to claim 12, wherein the mixed dispersion medium is at least one medium selected from the group consisting of a toluene/alcohol mixed dispersion medium, a butyl acetate/alcohol mixed dispersion medium, an N,N-dimethylacetamide/alcohol mixed dispersion medium, a diethylene glycol dimethyl ether/monoethanolamine mixed dispersion medium, a diethylene glycol dimethyl ether/diethanolamine mixed dispersion medium and a diethylene glycol dimethyl ether/triethanolamine mixed dispersion medium.

15. The calcium oxide dispersion liquid according to claim 1, which contains a dispersant.

16. The calcium oxide dispersion liquid according to claim 15, wherein the dispersant is at least one compound selected from nonionic surfactants.

17. The calcium oxide dispersion liquid according to claim 16, wherein the nonionic surfactant has a hydroxyl group.

18. The calcium oxide dispersion liquid according to claim 16, wherein the nonionic surfactant is an adduct of glycerin with polypropylene oxide.

19. The calcium oxide dispersion liquid according to claim 1, wherein the organic dispersion medium has a viscosity of not more than 3.0 mPa·s (20° C.).

20. A process for producing the calcium oxide dispersion liquid according to claim 1, which comprises the steps of:
filling calcium oxide fine particles, an organic dispersion medium, and beads having a diameter of 5 to 200 μm into a container; and
stirring these materials.

21. The process according to claim 20, wherein the stirring is carried out in an atmosphere of an inert gas having a water content of not more than 10 ppm (by mol).

22. The process according to claim 20, wherein the organic dispersion medium to be filled in the container has a water content of less than 1,000 ppm (by mass).

23. The calcium oxide dispersion liquid according to claim 5, wherein the calcium complex is a complex of calcium and a β-diketone compound.
